(19) United States
(12) Patent Application Publication
(10) Pub. No.: US 2024/0416704 A1
(43) Pub. Date: Dec. 19, 2024

(54) METHOD FOR OPERATING A MOTOR VEHICLE

(71) Applicant: AUDI AG, Ingolstadt (DE)

(72) Inventor: Adrian MIHAILESCU, Ingolstadt (DE)

(73) Assignee: AUDI AG, Ingolstadt (DE)

(21) Appl. No.: 18/681,919

(22) PCT Filed: Jul. 28, 2022
(86) PCT No.: PCT/EP2022/071224

§ 371 Date: Feb. 7, 2024

(30) Foreign Application Priority Data
Oct. 28, 2021 (DE) 10 2021 128 061.3

(51) Int. Cl. B60G 17/0165; B60G 17/018

(52) U.S. Cl. CPC B60G 17/0165; B60G 17/018; B60G 2800/012

(57) ABSTRACT

A method for operating a motor vehicle. The motor vehicle has an active wheel suspension, by which each wheel can be subjected individually to vertical forces and/or lifting movements. An actual excitation of the vehicle body of the motor vehicle is determined and the determined actual excitation is compared to a stored reference excitation, and if the determined actual excitation is less than the stored reference excitation, the active wheel suspension is activated to create a vertical rolling movement of the vehicle body.

### FIELD

The invention relates to a method for operating a motor vehicle.

### BACKGROUND

Currently, the roadway surfaces of many roads are embodied as high quality and thus “perfectly flat”. At the same time, the chassis installed currently ensure a very high level of driving comfort with very low vertical excitation of the vehicle body.

In particular in vehicles from the premium segment, which generally have active chassis systems, the vertical driving experience is extremely monotonous, i.e., the occupants hardly still feel any road-related vibrations or excitations and are also no longer “rocked” during the journey. This is a problem, for example, for mothers and fathers who want to use the vertical excitation of the vehicle structure to “rock to sleep” babies and toddlers during the journey. In addition, tired drivers often tend to fall asleep more quickly at the wheel during a monotonous journey. This means that an extremely comfortable chassis is a disadvantage for the tired driver.

A generic method for operating a motor vehicle is disclosed in DE 10 2019 003 244 A1. The method disclosed is characterized in that the rolling movements of the vehicle body that occur during the journey of a motor vehicle are maintained even when the motor vehicle is at a standstill in order not to wake up sleeping occupants when the journey is interrupted, for example at an intersection.

### SUMMARY

The invention is based on the object of refining a method for operating a motor vehicle according to the type specified in the preamble of claim 1 in such a way that an increase in safety in road traffic is made possible.

The method according to the invention is characterized in that a vertical actual excitation of the vehicle body of the motor vehicle is determined and the determined actual excitation is compared to a stored reference excitation, wherein if the determined actual excitation is less than the stored reference excitation, the active wheel suspension is activated to create a vertical rolling movement of the vehicle body.

For the sake of completeness, it is to be noted that the reference excitation is to be understood as a vertical excitation of the vehicle body, which the vehicle body normally experiences during a journey over a road. The reference excitation can be determined by means of tests, for example recording the excitation when the motor vehicle is traveling over a road with a predetermined/defined roughness of the roadway surface. However, it is also conceivable that the reference excitation is determined in real driving operation.

### DETAILED DESCRIPTION

The method according to the invention now advantageously ensures that a driving situation-which is potentially dangerous, particularly for an overtired driver-namely monotonous cruising on a “perfectly flat” road, can be identified and, after identifying a potentially dangerous driving situation, appropriate countermeasures are also provided by activating the active wheel suspension to create an “artificial” vertical rolling movement. This means that the risk of a tired driver falling asleep due to insufficient vertical stimulation of the motor vehicle body can be actively counteracted, which in turn contributes to increasing safety in road traffic.

In addition to the described increase of the safety in road traffic, the invention can, of course, also serve as an indicator for the initiation of a “baby or toddler sleep mode”: i.e., even driving situations which, due to a lack of vertical excitation of the vehicle structure, could complicate a desired “rocking to sleep” of a baby or toddler, or could result in an awakening of an already sleeping baby or toddler, can now be proactively identified, so that by initiating the active suspension of the wheel, an appropriate vertical stimulation, going to sleep or further sleep of the baby or infant can be ensured.

A further advantage is that—in particular in motor vehicles of the premium class, in addition to an active wheel suspension, corresponding sensors are usually installed, by means of which a vertical excitation of the motor vehicle body is determinable—a cost-effective and low-effort implementation of the method according to the invention is made possible.

In order to alert the driver to the corresponding driving situations, the driver is preferably informed during the journey of the motor vehicle that the stored reference excitation has not been reached by means of an optical and/or acoustic signal.

It is preferably provided that after activation of the active wheel suspension, the creation of the vertical rolling movement of the vehicle body is only carried out after manual activation by the driver. This means that the driver activates the active suspension of the wheel “at the push of a button”, which then generates, via eABC, active damper controllers, or the like, the corresponding vertical excitations, which simulate a rolling motion on a road. This ensures that the vehicle occupants feel vertical roadway stimuli, although the road is “perfectly flat”.

However, it is also conceivable that after the active wheel suspension has been activated, the creation of the vertical rolling movement of the vehicle body, which simulates a rolling movement on a road, is started automatically.

The creation of the vertical rolling movement is preferably carried out in such a way that the entire vehicle body is exited evenly.

According to a particularly preferred embodiment of the method according to the invention, the creation of the vertical rolling movement is carried out in such a way that a partial area of the vehicle body that can be freely selected by the driver is excited to a greater extent in comparison to the remaining area of the vehicle body. This design has the positive effect of allowing a targeted use of the vertical excitation, for example, vertical excitation only in the driver's seat to prevent a driver from falling asleep, or also, for example, excitation of the area of the rear seat and/or the front passenger seat to “rock to sleep” a baby placed here.

Preferably, it is also provided that in order to create the vertical rolling movement of the vehicle body, the active wheel suspension is excited with a sinusoidal excitation frequency that simulates a random or a real rolling movement on a road.

A further preferred embodiment of the method according to the invention provides that the vertical rolling movement of the vehicle body can be adjusted by the driver both with respect to the intensity and with respect to the frequency.

The invention is furthermore based on the object of refining a motor vehicle which comprises an active wheel suspension, by means of which each wheel can be individually subjected to vertical forces and/or lifting movements, as well as a regulating/control unit which regulates/controls the active wheel suspension, in such a way that in addition to a high level of driving comfort, increased safety in road traffic is also ensured.

All embodiments of the method for operating a motor vehicle according to the invention may be transferred analogously to the motor vehicle according to the invention, so that the above-mentioned advantages can be achieved thereby.

1-10. (canceled)

11. A method for operating a motor vehicle, wherein the motor vehicle has an active wheel suspension, by which each wheel can be subjected individually to vertical forces and/or lifting movements, wherein an actual excitation of the vehicle body of the motor vehicle is determined and the determined actual excitation is compared to a stored reference excitation, wherein, if the determined actual excitation is less than the stored reference excitation, the active wheel suspension is activated to create a vertical rolling movement of the vehicle body.

12. The method according to claim 11, wherein during the journey of the motor vehicle, it is communicated that the stored reference excitation has not been reached by means of an optical and/or acoustic signal.

13. The method according to claim 11, wherein after activation of the active wheel suspension, the creation of the vertical rolling movement of the vehicle body is only carried out after manual activation by the driver.

14. The method according to claim 11, wherein after the active wheel suspension has been activated, the creation of the vertical rolling movement of the vehicle body is started automatically.

15. The method according to claim 11, wherein the creation of the vertical rolling movement is carried out in such a way that the entire vehicle body is exited evenly.

16. The method according to claim 11, wherein the creation of the vertical rolling movement is carried out in such a way that a partial area of the vehicle body is excited to a greater extent in comparison to the remaining area of the vehicle body.

17. The method according to claim 11, wherein in order to create the vertical rolling movement of the vehicle body, the active wheel suspension is excited with a sinusoidal excitation frequency that simulates a random or a real rolling movement on a road.

18. The method according to claim 11, wherein the vertical rolling movement of the vehicle body is adjustable with respect to intensity and frequency.

19. A motor vehicle, comprising an active wheel suspension, by means of which each wheel can be individually subjected to vertical forces and/or lifting movements, and a regulating/control unit that regulates/controls the active wheel suspension, wherein the active wheel suspension is operated according to claim 11.

20. The motor vehicle according to claim 19, wherein the control unit is configured to carry out a method for operating the motor vehicle, wherein the motor vehicle has an active wheel suspension, by means of which each wheel can be subjected individually to vertical forces and/or lifting movements, wherein an actual excitation of the vehicle body of the motor vehicle is determined and the determined actual excitation is compared to a stored reference excitation, wherein, if the determined actual excitation is less than the stored reference excitation, the active wheel suspension is activated to create a vertical rolling movement of the vehicle body.

21. The method according to claim 12, wherein after activation of the active wheel suspension, the creation of the vertical rolling movement of the vehicle body is only carried out after manual activation by the driver.

22. The method according to claim 12, wherein after the active wheel suspension has been activated, the creation of the vertical rolling movement of the vehicle body is started automatically.

23. The method according to claim 12, wherein the creation of the vertical rolling movement is carried out in such a way that the entire vehicle body is exited evenly.

24. The method according to claim 13, wherein the creation of the vertical rolling movement is carried out in such a way that the entire vehicle body is exited evenly.

25. The method according to claim 14, wherein the creation of the vertical rolling movement is carried out in such a way that the entire vehicle body is exited evenly.

26. The method according to claim 12, wherein the creation of the vertical rolling movement is carried out in such a way that a partial area of the vehicle body is excited to a greater extent in comparison to the remaining area of the vehicle body.

27. The method according to claim 13, wherein the creation of the vertical rolling movement is carried out in such a way that a partial area of the vehicle body is excited to a greater extent in comparison to the remaining area of the vehicle body.

28. The method according to claim 14, wherein the creation of the vertical rolling movement is carried out in such a way that a partial area of the vehicle body is excited to a greater extent in comparison to the remaining area of the vehicle body.

29. The method according to claim 12, wherein in order to create the vertical rolling movement of the vehicle body, the active wheel suspension is excited with a sinusoidal excitation frequency that simulates a random or a real rolling movement on a road.

30. The method according to claim 13, wherein in order to create the vertical rolling movement of the vehicle body, the active wheel suspension is excited with a sinusoidal excitation frequency that simulates a random or a real rolling movement on a road.
